(19) United States
(12) Patent Application Publication
(10) Pub. No.: US 2011/0115990 A1
(43) Pub. Date: May 19, 2011

(54) DISPLAY SYSTEM

(76) Inventor: Joe Bhaktiar, Arlington, VA (US)

(21) Appl. No.: 12/941,370

(22) Filed: Nov. 8, 2010

Related U.S. Application Data
(60) Provisional application No. 61/260,896, filed on Nov. 13, 2009.

(51) Int. Cl. H04N 5/64

(52) U.S. Cl. 348/794; 348/836; 348/837; 348/E05.128

(57) ABSTRACT

According to at least one exemplary embodiment, a display, such as a flat panel display, may be positioned or oriented in one or more non-traditional environments. The display may be such that video or image data may be shown on a front portion, a back portion or both a front and back portion. Additionally, the display can include capabilities to be updated to show any desired type of data at any time, including dynamic data that may act to conceal, camouflage or otherwise hide content located behind a display. Additionally, the display may receive its input data from any of a variety of sources, for example a computer or a camera. Additionally, the display may be formed, positioned or utilized with any desired number of additional displays.

### CROSS-REFERENCE

This patent application claims benefit under 35 U.S.C. §119(e) to U.S. Provisional Patent Application No. 61/260,896, filed Nov. 13, 2009, the disclosure of which is incorporated by reference herein in its entirety.

### BACKGROUND

Display systems, such as flat panel displays are used in a variety of modern applications. For example, displays provide output for video programming as well as computer data. Additionally, displays are becoming thinner and lighter in weight, allowing for them to be positioned and oriented in manners not previously available with previous types of displays, such as cathode ray tubes (CRTs).

In addition, current manners of concealment typically involve some sort of camouflaging. However, in changing or dynamic environments, standard forms of camouflage may not provide adequate concealment or may otherwise lose some desired usefulness.

### SUMMARY

According to at least one exemplary embodiment, a display, such as a flat panel display, may be positioned or oriented in one or more non-traditional environments. The display may be such that video or image data may be shown on a front portion, a back portion or both a front and back portion. Additionally, the display can include capabilities to be updated to show any desired type of data at any time, including dynamic data that may act to conceal, camouflage or otherwise hide content located behind a display. Additionally, the display may receive its input data from any of a variety of sources, for example a computer or a camera. Additionally, the display may be formed, positioned or utilized with any desired number of additional displays.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram of an automobile fitted with one or more displays.

FIG. 2 is an exemplary diagram of an automobile showing a function of a display.

FIG. 3 is another exemplary diagram of an automobile showing a function of a display.

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

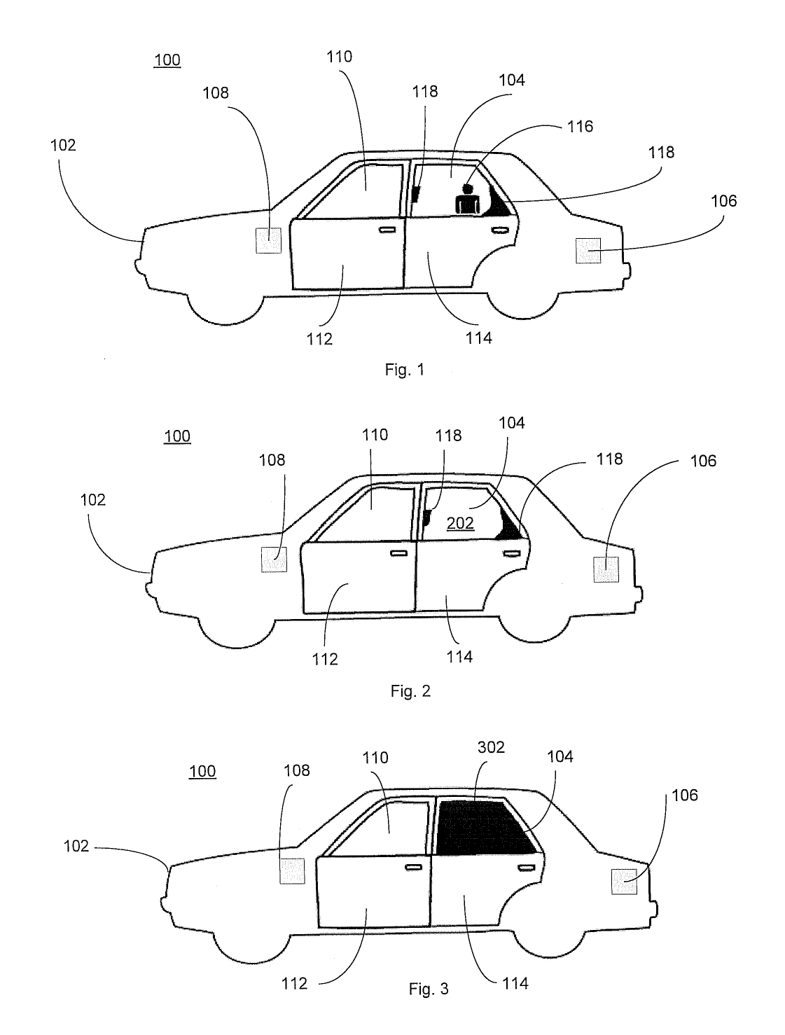

According to some exemplary embodiments, and generally referring to FIGS. 1-3, one or more displays or projectable surfaces, for example display 104, may be utilized in any of a variety of fashions or manners. Any display 104 utilized could be a flat panel display, such as a liquid crystal display (LCD), light emitting diode (LED) display, plasma display or the like. The display or displays 104 may be formed to be of any desired thickness and may be capable of displaying any type of image data, for example static image data, video image data, any combination of static image data and video or any other data capable of being displayed. Additionally, the displays 104 may possess any number of other characteristics, including, when desired, transparency, semi-transparency, translucency, opaqueness and the like. Further, any display 104 may have any other functionality known in the art, such as touch screen controllability or other manipulation of data thereon. Also, any displays 104 utilized may be formed in any size or shape and may include an ability to be contoured, flexed, shaped or otherwise manipulated in size, shape, orientation and/or connection with any other object. Any displays 104 may further include any type of covering so as to improve or adjust image display quality, filter image quality, protect the display from damage or ambient elements or otherwise cover the display. Further, the displays 104 may provide status and condition updates to a controller or appropriate personnel, for example, as to the functionality of the display 104, if there is a data error or if there is some form of physical damage to the display or its components.

Any display utilized herein may be capable of receiving data, such as image or video data, from any number of available sources. In some exemplary embodiments, a display may receive data from a processor or display driver 106 associated with any known data storage, transmitter, receiver or transceiver which may be mounted in or on the display 104 or which may be remotely located and which may transmit data in a wired or wireless fashion, or any other known manner As shown in the exemplary figures, display driver 106 may be located in a trunk portion of an automobile, although it is envisioned that any form of display driver may be located in any desired location proximate or remote any desired displays. Also, any data stored may be any type of image data, as described above. Additionally, a display 104 may receive image or video data from one or more cameras which may be positioned to provide any desired image or video data to the display 104 from any desired location. Further, data may be transmitted to any desired display 104 through any automatic or manual means. For example, a remotely located control center, such as that associated with display driver 106 or a separate control unit 108, may provide instructions for data to be displayed or an algorithm or artificial intelligence may be used to provide data to a display. Alternatively, one or more cameras associated with a display may be either manually or automatically operated.

In one exemplary embodiment, any number of displays 104 may be dynamically mounted on or coupled to a vehicle, for example an automobile 100 as shown in exemplary FIGS. 1-3, and may be moveable or rotatable in any desired fashion. The displays 104 may be such that they have any of the capabilities or characteristics of those described above. For example, one or more displays may be mounted in a traditional location for a car window of automobile 100. This could include mounting display in the window locations of doors 112 and 114, as well as any other desired location of body 102 of automobile 100. The display 104 may provide image or video outputs both inside the automobile and outside the automobile. Additionally any displays 104 may be mounted such that they are capable of movement, for example retracting similar to automobile windows as known in the art. Thus, in the exemplary embodiments shown herein, a display, such as display 104, may be capable of retracting fully or partially into door 114 of automobile 100. However, in further exemplary embodiments, displays may be mounted in any location, for example on any panel or surface of a vehicle such as an automobile or any other location as desired. Thus, in other exemplary embodiments, any display could be mounted in any other desired location of automobile 100, for example on door 112, door 114 or any other location of automobile body 102. Additionally, automobile 100 could also be partially or fully enclosed within a single or multiple displays, for example like a box shield covering automobile 100, and any image data may be provided to the enclosing displays or projected onto the displays.

Further, in this example, any image shown on any one display, multiple displays or any combination of displays can be received and outputted in any of the manners described above. Further, in some exemplary embodiments, a display, such as display 104, may be transparent or translucent or semi-transparent at any desired time. For example, as shown in FIG. 1, display 104 is transparent. This can allow for an outside viewer to see passenger 116 and interior elements 118 of automobile 100, similar to how an outside viewer would be able to see through a traditional automobile window.

In another exemplary embodiment, and as shown in exemplary FIG. 2, image data 202 may be displayed on the display 104 that can effectively camouflage or obscure anyone or anything that may be inside automobile 100. For example, automobile 100 may have displays mounted in areas where rear windows are typically located on an automobile, such as display 104 and a display located on an opposite side of automobile 100 from display 104. Data 202 may be provided to the displays that can show the interior of the automobile 100 as being devoid of occupants or may show any other image as being present inside the automobile. Thus, as shown in exemplary FIG. 2, image data 202 showing interior elements 118 of automobile 100 may be displayed on display 104, thus suggesting to an outside viewer that automobile 100 is devoid of any passengers seated behind display 104 or door 114. Additionally, data 202 may be received from one or more cameras that dynamically or constantly update the image on one or more displays (for example with video data), along with a static image of an interior of the automobile, so that it may appear that there is nothing or nobody occupying a desired portion of the automobile. For example, a rear, driver's side display 104 mounted in a location where a window may commonly be mounted may display an image of the interior elements 118 of automobile 100. The image may further include video data that dynamically shows an effective view from a passenger side rear window (not pictured) of the automobile. Thus, for any viewer looking at the automobile 100, it would appear as if they are looking through the rear of the car, through traditional transparent or translucent windows.

In other alternative exemplary embodiments, an image displayed on one or more displays of an automobile may be such that any other desired image or video data 302 is shown. Image or video data 302 may be any desired data, including data which would obscure any interior elements of automobile 100. Additionally, viewers located inside the automobile 100, for example passenger 116, utilizing such displays may be able to choose any image or video data, for example using controller 108, to display on either the interior or exterior displays or may choose to render the displays transparent or translucent or opaque. Further, when any image is shown on a display facing away from an automobile, the image may prevent any viewers or mechanical or electronic viewing devices, such as cameras, from seeing through the display to anything situated on an opposite side of the display.

In still further exemplary embodiments, displays mounted on an automobile or any other vehicle may provide any type of output, for example any other stored or remotely provided image or video data. Such data can include both static and dynamic advertisements, programming or any other desired information or data.

In still other exemplary embodiments, an array of displays may be utilized on any surface so as to provide image or video data on varying scales. In these exemplary embodiments, individual displays may be provided with individual image data or the display may function as an active array of displays with image or video data being distributed to appropriate portions of the array.

In another exemplary embodiment, any number of the displays discussed herein may be mounted on or otherwise utilized with any type of building or structure. The displays can function to show any video or image data, as described above in other exemplary embodiments. Additionally, the displays may be designed to prevent outside viewers or viewing devices to see any objects or people located inside the building or structure. Similarly, the displays may be such that they can be made transparent, translucent, tinted or otherwise allow for any desired party, for example viewers inside the building or viewers outside the building, to see through the displays. Additionally, as desired, the displays may be provided with video or image data that camouflage or cloak all or portions of the building or structure. In still further exemplary embodiments, any number of displays associated with a building or structure, or any other vehicle, vessel or device discussed herein, may be utilized together or separate to show any other data, for example billboard or advertisement data.

In still other exemplary embodiments, a display may be mounted on an outside portion of a structure and provide a view to the interior of the structure. For example, a display may be mounted on an exterior portion of a refrigerator. The display may then be provided with image (static or video) data of the contents of the refrigerator, for example through the use of a camera. The display may then be activated at any time by a user to view the interior of the refrigerator without the need to open the refrigerator or any component associated with the refrigerator.

As discussed previously, any number of displays may be mounted on any surface of an automobile, whether the surface is retractable, such as a window or sunroof, flat, such as a panel or curved or contoured, where a display may be correspondingly curved or contoured. Further to these and other examples discussed herein, any number of displays may be coupled with any desired vehicle or vessel, such as, but not limited to, airplanes, trains and boats or ships. Similar to the above-described embodiments, the displays may be utilized such that portions of a vehicle or vessel may be obscured or an image shown to prevent any viewer or device from looking into the vehicle or vessel. Additionally, a vehicle or vessel may be wrapped in displays, for example using contoured displays, and the vehicle or vessel may be cloaked, concealed or camouflaged. The cloaking, concealing or camouflaging may be done in any of the manners described herein. In one non-limiting example, a ship or boat may have its exterior covered with displays, for example contoured or contourable displays. The displays may then show or display images or video of an ambient scene that may be presented on an alternative or opposite side of the boat or ship. Thus, to an outside viewer or device, the appearance of the boat or ship may be wholly or partially concealed as it would appear to blend in or otherwise be concealed by the ambient environment, as shown on the displays.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for displaying images, comprising,
a display movably mounted on an object and incorporated into the structure of the object;
wherein the display can project at least one of static video data, dynamic video data and a combination of static video data and dynamic video data.

2. The apparatus of claim 1, wherein the display is one of a flat panel display, a liquid crystal display, and light-emitting diode display, and a plasma display.

3. The apparatus of claim 2, wherein the display is incorporated into the structure of the object with a contoured shape of the display.

4. The apparatus of claim 1, wherein the display comprises a covering.

5. The apparatus of claim 1, wherein the display comprises an array of displays.

6. The apparatus of claim 1, wherein the display is mounted on a vehicle.

7. The apparatus of claim 1, wherein the display is mounted on a building, wall or appliance.

8. The apparatus of claim 6, wherein the display is mounted on an automobile.

9. The apparatus of claim 1, wherein the video data comprises images that are manipulated to display a desired image.

10. The apparatus of claim 1, wherein the video data cloaks the interior of the object by projecting an image that disguises true contents of the interior of the object.

11. The apparatus of claim 1, wherein the images are at least one of transparent, translucent, semi-transparent, or opaque.

12. The apparatus of claim 8, wherein the display is mounted in the same configuration as an automobile window.

13. The apparatus of claim 12, wherein the display is retractable.

14. The apparatus of claim 8, wherein the display is mounted on the body panels of the automobile.

15. A method for displaying images comprising:
mounting a display on an object;
displaying an image on the display; and
concealing anything located behind a mounted display by displaying predetermined image data on the display.

16. The method of claim 15, wherein the image data is supplied by at least one video camera.

17. The method of claim 15, further comprising dynamically mounting the display on an object such that it is at least one of moveable and contourable.

18. The method of claim 15, wherein the image data is supplied by at least one of a data storage device, a transmitter and receiver and a transceiver.
